(19) United States
(12) Patent Application Publication
(10) Pub. No.: US 2026/0288348 A1
(43) Pub. Date: Sep. 24, 2026

(54) MEMORY SYSTEM AND READING METHOD

(71) Applicant: Kioxia Corporation, Tokyo (JP)

(72) Inventor: Keita OZAWA, Yokohama Kanagawa (JP)

(21) Appl. No.: 19/323,622

(22) Filed: Sep. 9, 2025

(30) Foreign Application Priority Data
Mar. 21, 2025 (JP) 2025-047081

(51) Int. Cl. G06F 3/06

(52) U.S. Cl. CPC G06F 3/0619; G06F 3/0659; G06F 3/0673

(57) ABSTRACT

A memory system includes a non-volatile memory and a controller. The controller is configured to calculate a parameter value representing a data retention stress, and perform a read operation. The read operation includes a primary read using a first read voltage, a tracking read to determine an optimum read voltage when a first error correction on data read through the primary read fails, and a secondary read using the optimum read voltage. The tracking read comprises data read using, as an initial read voltage, a read voltage that is shifted from the first read voltage by a shift value, and then using read voltages further shifted from the initial read voltage. The controller is configured to determine the shift value to be a first shift value based on a predetermined bit count of data read through the primary read when the parameter value is greater than a first threshold.

### CROSS-REFERENCE TO RELATED APPLICATION

This application is based upon and claims the benefit of priority from Japanese Patent Application No. 2025-047081, filed Mar. 21, 2025, the entire contents of which are incorporated herein by reference.

### FIELD

Embodiments described herein relate generally to a memory system and a reading method.

### BACKGROUND

A memory system includes a memory device that includes a plurality of memory cells. When reading data from the memory device, a read voltage is applied to a word line connected to the memory cell to be read. When the read voltage is not appropriate, the read data may include many errors. In this case, latency increases and reading performance decreases due to the need to execute error correction and retry reading.

### BRIEF DESCRIPTION OF THE DRAWINGS

FIG. 1 is a block diagram showing an example of a memory system according to an embodiment.

FIG. 2 is a block diagram showing an example of a memory chip.

FIG. 3 is a circuit diagram showing an example of a memory cell array.

FIG. 4 is a diagram showing an example of a distribution of threshold voltages of memory cell.

FIG. 5 is a diagram showing an example of data stored in a RAM.

FIGS. 6A to 6C are a diagram showing an example of a change in the number of read bits according to a change in threshold voltages of the memory cell.

FIG. 7 is a diagram showing an example of a relationship between a shift candidate value and the number of read bits.

FIG. 8 is a flowchart showing an example of a write process.

FIG. 9 is a flowchart showing an example of a read process.

FIG. 10 is a flowchart showing an example of a first read process when a data retention stress exceeds a threshold value.

FIG. 11 is a flowchart showing a first example of a second read process when a data retention stress does not exceed a threshold value.

FIG. 12 is a flowchart showing the first example of the second read process when a data retention stress does not exceed a threshold value.

FIG. 13 is a flowchart showing the first example of the second read process when a data retention stress does not exceed a threshold value.

FIG. 14 is a flowchart showing a second example of the second read process when a data retention stress does not exceed a threshold value.

FIG. 15 is a flowchart showing the second example of the second read process when a data retention stress does not exceed a threshold value.

FIG. 16 is a flowchart showing the second example of the second read process when a data retention stress does not exceed a threshold value.

### DETAILED DESCRIPTION

Embodiments provide a memory system and a reading method which are capable of improving reading performance.

In general, according to an embodiment, a memory system includes a non-volatile memory including a plurality of memory cells, and a controller connected to the non-volatile memory. The controller is configured to calculate a parameter value representing a data retention stress, and perform a read operation to read data from the non-volatile memory. The read operation includes: i) a primary read using a first read voltage; ii) a tracking read to determine an optimum read voltage when a first error correction with respect to data read through the primary read fails; and iii) a secondary read using the optimum read voltage. The tracking read comprises data read using, as an initial read voltage, a read voltage that is shifted from the first read voltage by a shift value, and then using one or more read voltages further shifted from the initial read voltage. The controller is configured to determine the shift value to be a first shift value based on a predetermined bit count of data read through the primary read when the parameter value is greater than a first threshold.

Hereinafter, an embodiment will be described with reference to the drawings. The following description is intended to illustrate devices and methods for embodying the technical idea of the embodiment, and the technical idea of the embodiment is not limited to the structures, shapes, arrangements, or materials of components to be described below. Modifications that can be easily conceived by a person skilled in the art are naturally included within the scope of the disclosure. In order to make the description clearer, the sizes, thicknesses, planar dimensions, or shapes of elements may be changed from the actual ones to show a schematic representation. Elements having different dimensional relationships or ratios may be provided in a plurality of drawings. Corresponding elements in the plurality of drawings may be given the same reference numerals and overlapping descriptions may be omitted. Some elements may be given a plurality of names, but these examples of names are merely examples and do not deny giving other names for these elements. Even when elements are not given a plurality of names, this does not deny giving other names to the elements. Connections may include not only direct connections but also connections via other elements. Unless the number of elements is specified as plural, the number of elements may be single or plural.

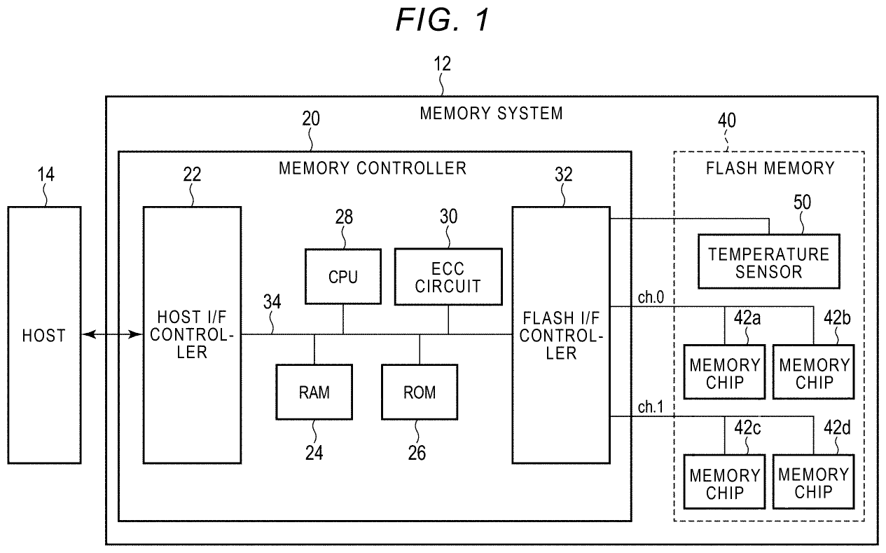

FIG. 1 is a block diagram showing an example of a memory system 12 according to an embodiment. The memory system 12 is connected to a host 14 via a cable, a connector, a socket, a solder ball, or a network. The memory system 12 may be mounted on a printed wiring board provided in the host 14. The host 14 is an information processing device configured to control the memory system 12. The host 14 is, for example, a server device, a personal computer, an in-vehicle device, or a mobile information processing device. The host 14 can issue an access request to the memory system 12. The access request includes a read request and a write request. The read request is a request to read data stored in the memory system 12. The write request is a request to write data to the memory system 12.

The memory system 12 includes a memory controller 20 and a flash memory 40. The flash memory 40 is, for example, a NAND type flash memory. The memory system 12 is, for example, a solid state drive (SSD), a universal flash storage (UFS) device, a universal serial bus (USB)™ memory, or a secure digital (SD) card. The flash memory 40 is an example of a non-volatile memory. Instead of the NAND type flash memory, other non-volatile memories may be used for the flash memory 40. Other examples of non-volatile memories include a NOR type flash memory, a magneto-resistive random access memory (MRAM), a phase change random access memory (PRAM), a resistive random access memory (ReRAM), and a ferroelectric random access memory (FeRAM).

The memory controller 20 includes a host interface controller (host I/F controller) 22, a random access memory (RAM) 24, a read only memory (ROM) 26, a central processing unit (CPU) 28, an error correcting code (ECC) circuit 30, and a flash interface controller (flash I/F controller) 32. The host I/F controller 22, the RAM 24, the ROM 26, the CPU 28, the ECC circuit 30, and the flash I/F controller 32 are connected to a bus 34. The memory controller 20 may be configured with a system on chip (SoC) in which the above-mentioned components are integrated into one chip. Some of these components may be provided outside the memory controller 20.

The host I/F controller 22 controls a communication interface between the host 14 and the memory system 12, and controls data transfer between the host 14 and the RAM 24 under the control of the CPU 28. Examples of the communication interface between the host 14 and the memory system 12 include a small computer system interface (SCSI), a serial attached SCSI (SAS), an AT attachment (ATA), a serial ATA (SATA), a PCI express (PCIe)™, an Ethernet™, e channel, an NVM express (NVMe)™, a universal serial bus (USB)™, and a universal asynchronous receiver/transmitter (UART)™.

Examples of the RAM 24 include a dynamic random access memory (DRAM), a static random access memory (SRAM), and the like, but are not limited thereto.

The RAM 24 functions as a buffer for data transfer between the host 14 and the flash memory 40. The RAM 24 provides a work area to the CPU 28. Firmware (programs) stored in the ROM 26 is loaded into the RAM 24 when the memory system 12 is in operation. The data stored in the RAM 24 will be described below.

The CPU 28 is an example of a hardware processor. The CPU 28 controls the memory controller 20 by executing the firmware loaded into the RAM 24. The CPU 28 controls writing, reading, and erasing of data, as described below. The CPU 28 includes a timer. It is noted that a plurality of CPUs 28 may be provided for each operation.

The ECC circuit 30 performs encoding for error correction on data to be written to the flash memory 40. An error correction code is generated by this encoding. The data to be written and the error correction code are written to the flash memory 40. The data to be written with the error correction code added is also referred to as write data. When the data read from the flash memory 40 includes an error, the ECC circuit 30 executes error correction for the read data on the basis of the error correction code added during writing. The data to be read is also referred to as read data.

The flash I/F controller 32 controls data transfer between the RAM 24 and the flash memory 40 under the control of the CPU 28. An example of a standard used for data transfer between the flash I/F controller 32 and the flash memory 40 is Toggle DDR or an open NAND flash interface (ONFI)

The memory controller 20 and the flash memory 40 are connected via a plurality of channels, for example, two channels Ch0 and Ch1. The number of channels is not limited to plural, and may be one. Furthermore, when the number of channels is plural, the number of channels may be three or more. The flash I/F controller 32 controls data transfer via the channels Ch0 and Ch1.

The flash memory 40 includes a plurality of, for example, four memory chips 42a, 42b, 42c, and 42d. Two memory chips 42a and 42b are connected to the channel Ch0. Two memory chips 42c and 42d are connected to the channel Ch1. Three or more memory chips may be connected to each channel. The flash memory 40 further includes a temperature sensor 50. The temperature sensor 50 measures the temperature of the flash memory 40. The temperature measured by the temperature sensor 50 or a temperature inferred from the temperature measured by the temperature sensor 50 is transmitted to the flash I/F controller 32 via the channel Ch or via a signal line separate from the channel Ch. The temperature sensor 50 may be provided in the memory controller 20, not in the flash memory 40. The four memory chips 42a, 42b, 42c, and 42d and the temperature sensor 50 are sealed in one package. The memory chips 42a and 42b may be sealed in one package, and the memory chips 42c and 42d may be sealed in another package. In this case, the temperature sensor 50 may be sealed in each package individually. It is noted that the temperature sensor 50 may not be provided in the flash memory 40, but may be disposed in the vicinity of the flash memory 40 or the memory controller 20.

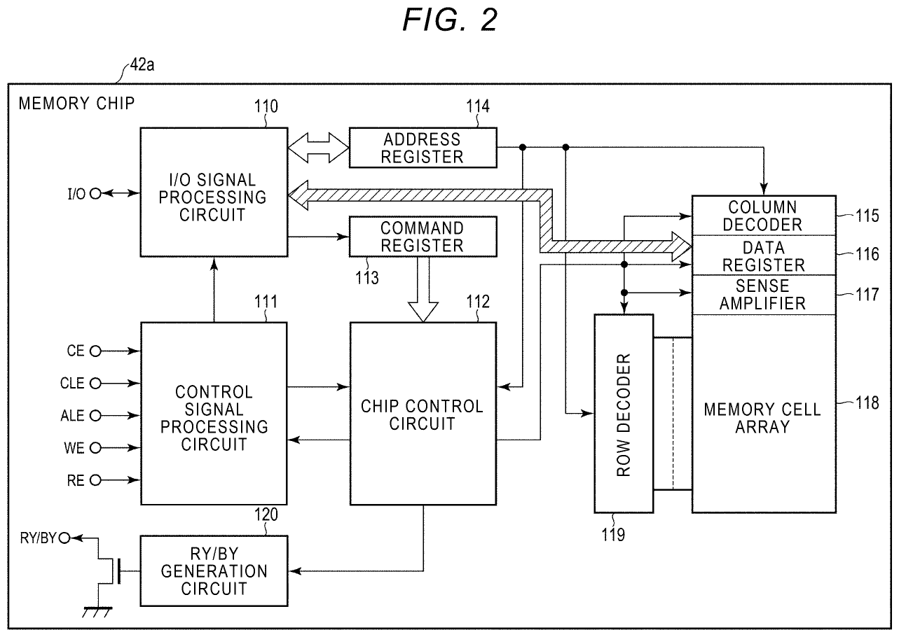

FIG. 2 is a block diagram showing an example of the memory chip 42a. The other memory chips 42b, 42c, and 42d are configured in the same manner. FIG. 2 shows an example in which the flash memory 40 including the memory chip 42a is a NAND type flash memory.

The memory chip 42a includes an input/output signal processing circuit (I/O signal processing circuit) 110, a control signal processing circuit 111, a chip control circuit 112, a command register 113, an address register 114, a ready/busy (RY/BY) generation circuit 120, a memory cell array 118, a column decoder 115, a data register 116, a sense amplifier 117, and a row decoder 119.

The channel Ch0 that connects the memory chip 42a and the flash I/F controller 32 includes an input/output (I/O) signal line, a control signal line, and a ready/busy (RY/BY) signal line. The memory chip 42a includes a plurality of electrodes for connecting to each signal line. The I/O signal line is connected to the I/O signal processing circuit 110. The I/O signal line transmits data, addresses, various instructions, and various responses. The memory controller 20 transmits read instructions and write instructions to the memory chip 42a via the I/O signal line.

The control signal line include a chip enable (CE) signal line, a command latch enable (CLE) signal line, and an address latch enable (ALE) signal line, a write enable (WE) signal line, a read enable (RE) signal line, and the like. The control signal line is connected to the control signal processing circuit 111. The CE signal line transmits a signal indicating whether a target memory chip is being selected. The CLE signal line transfers a signal indicating that a signal transmitted using the I/O signal line is a command. The ALE signal line transfers a signal indicating that the signal transmitted using the I/O signal line is an address. The WE signal line transmits a signal for causing the signal on the I/O signal line to be taken in by the memory chip 42a. The RE signal line transmits a signal for causing the signal from the memory chip 42a to be output to the I/O signal line.

The RY/BY signal line is connected to the RY/BY generation circuit 120. The RY/BY signal line transmits a signal indicating whether or not the flash memory 40 is processing a certain operation. The signal transmitted on the RY/BY signal line, for example, indicates a ready state (RY) corresponding to a non-processing state when a logical value is at a high level, and indicates a busy state (BY) corresponding to a processing state when a logical value is at a low level.

The I/O signal processing circuit 110 is a buffer circuit for transmitting and receiving I/O signals between the memory chip 42a and the flash I/F controller 32. A command latched by the I/O signal processing circuit 110 is allocated to and stored in a command register 113. An address designating an access destination latched by the I/O signal processing circuit 110 is allocated to and stored in an address register 114. Data latched by the I/O signal processing circuit 110 is allocated to and stored in the data register 116. The I/O signal processing circuit 110 receives data from the data register 116 via a data line.

The address stored in the address register 114 includes a chip number, a row address, and a column address. The chip number is identification information for distinguishing the memory chip 42a. The chip number, the row address, and the column address are read out to the chip control circuit 112, the row decoder 119, and the column decoder 115, respectively.

The control signal processing circuit 111 receives a control signal, and allocates a register in which the I/O signal received by the I/O signal processing circuit 110 is stored, on the basis of the received control signal. In addition, the control signal processing circuit 111 transfers the received control signal to the chip control circuit 112.

The chip control circuit 112 is a circuit that transitions between states on the basis of various control signals received via the control signal processing circuit 111. The chip control circuit 112 controls the operation of the memory chip 42a. The RY/BY generation circuit 120 transitions the state of a signal transmitted on the RY/BY signal line between a ready state (RY) and a busy state (BY) under the control of the chip control circuit 112.

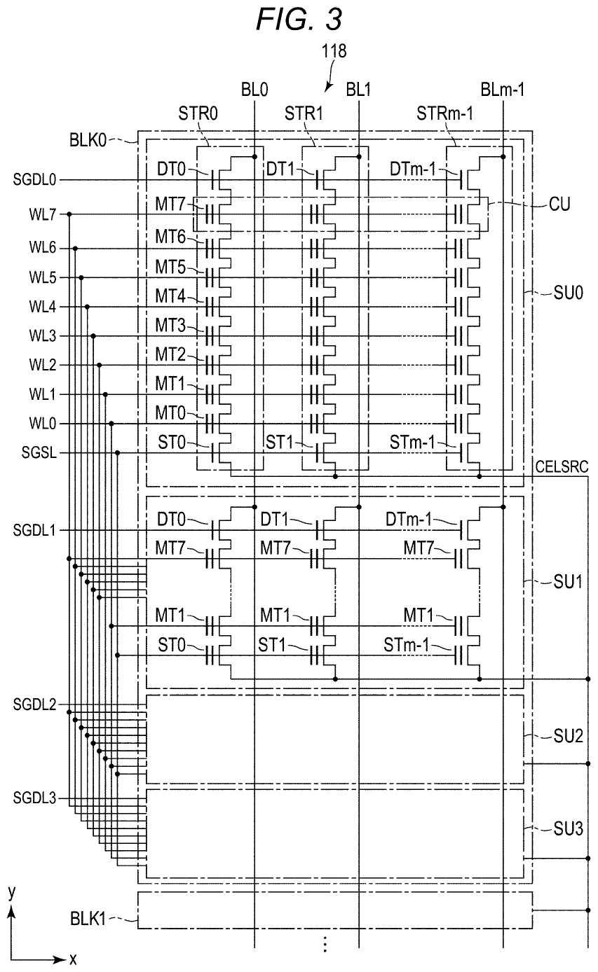

In reading, the sense amplifier 117 senses the state of the memory cell MT (see FIG. 3) provided in the memory cell array 118 and generates read data on the basis of the sensed state. The sense amplifier 117 stores the generated read data in the data register 116. The read data stored in the data register 116 is transmitted to the I/O signal processing circuit 110 through the data line, and is transferred from the I/O signal processing circuit 110 to the memory controller 20.

The memory cell array 118 includes a plurality of memory cells MT that can store data. The memory cell array 118 includes a plurality of physical blocks BLK (see FIG. 3). Each physical block BLK is a memory cell group that includes a plurality of memory cells MT. The physical block BLK is a minimum unit of data erasure. That is, all pieces of data stored in one physical block BLK are collectively erased. The physical block BLK is simply referred to as a block BLK.

FIG. 3 is a circuit diagram showing an example of the memory cell array 118. The memory cell array 118 includes a plurality of blocks BLK0, BLK1, . . . . The memory cell array 118 includes several hundreds to several thousands of blocks BLK. The memory cell array 118 is, for example, a NAND memory with a so-called three-dimensional structure in which a plurality of memory cells MT are disposed in a three-dimensional shape. The structure of the NAND memory is not limited to the three-dimensional structure. The memory cell array 118 may be a NAND memory with a so-called two-dimensional structure in which a plurality of memory cells MT are disposed in a planar shape.

Each of the m bit lines BL0 to BLm−1 is connected to a plurality of, for example, four strings STR in each of the blocks BLK0, BLK1, . . . , where m is an integer equal to or greater than 2. The string STR includes one first select gate transistor ST (ST0 or ST1 to STm−1), a plurality of memory cells MT (MT0 to MT7), and one second select gate transistor DT (DT0 or DT1 to DTm−1). The first select gate transistor ST0 (or ST1 to STRm−1), the plurality of memory cells MT0 to MT7, and the one second select gate transistor DT0 (or DT1 to DTm−1) are connected in series in this order between a source line CELSRC and one bit line BL0 (or BL1 to BLm−1). The m strings STRO to STRm−1 are connected to the plurality of different bit lines BL1 to BLm−1, respectively. The m strings STRO to STRm−1 connected to one common second select gate line (drain-side select gate line) SGDL configure one string unit SU. Each of the blocks BLK0, BLK1, . . . includes a plurality of, for example, four string units SU0 to SU3. Common word lines WL0 to WL7 and one first select gate line (source-side select gate line) SGSL are connected to each of the four string units SU0 to SU3.

Control gate electrodes of the first select gate transistors ST0 to STm−1 are connected to the first select gate line (source-side select gate line) SGSL. The first select gate line SGSL is a signal line that controls the control gate electrodes of the first select gate transistors ST0 to STm−1. The first select gate transistors ST0 to STm−1 selectively connect the plurality of memory cells MT0 to MT7 and the source line CELSRC on the basis of a voltage applied through the first select gate line SGSL. Four different first select gate lines SGSL may be connected to the string units SU0 to SU3, respectively.

Control gate electrodes of the second select gate transistors DT0 to DTm−1 are connected to the corresponding second select gate lines (drain-side select gate lines) SGDL0 to SGDL3, respectively. The second select gate lines SGDL0 to SDGL3 are signal lines that control the control gate electrodes of the second select gate transistors DT0 to DTm−1 connected thereto, respectively. The second select gate transistors DT0 to DTm−1 selectively connect the plurality of memory cells MT0 to MT7 and the bit lines BL0 to BLm−1 on the basis of voltages respectively applied through the second select gate lines SGDL0 to SGDL3.

The memory cell MT is configured with a metal oxide semiconductor field effect transistor (MOSFET) having a stacked gate structure. The stacked gate structure includes a floating gate formed with a tunnel oxide film interposed therebetween, and a control gate electrode formed on the floating gate with a gate insulating film interposed therebetween. The threshold voltage of the memory cell MT changes depending on the amount or number of charges stored in the floating gate. To the memory cell MT, positive charges are injected into the floating gate during writing, and positive charges are extracted from the floating gate during erasing. In the memory cell MT, any one of two or more data values can be written. The memory cell MT stores one of two or more data values in a non-volatile manner depending on a difference in threshold voltage.

In each of the blocks BLK0, BLK1, . . . , the control gate electrodes of the memory cells MT0 to MT7 are connected to the corresponding word lines WL0 to WL7, respectively. The word lines WL0 to WL7 are control signal lines for selecting a row of memory cells MT arranged in the X direction in the memory cell array 118. The word lines WL0 to WL7 are connected in common to a group of memory cells MT arranged in a row. The memory cells MT0 to MT7 are provided at intersections between the word lines WL0 to WL7 and the bit lines BL0 to BLm−1, respectively. The memory cells MT can be read or written by applying a read voltage or a write voltage to the selected word line WL connected to the memory cell MT to be subjected to reading or writing. It is noted that reading and writing of the memory cells MT will be described below.

In each of the blocks BLK0, BLK1, . . . , the word lines WL0 to WL7 corresponding to the same address are connected in common to the memory cells MT0 to MT7 in each of the four string units SU0 to SU3. In one string unit SU, a set of a plurality of memory cells MT that share one word line WL is referred to as a cell unit CU. Pieces of data are collectively written to and read out from a plurality of memory cells MT provided in one cell unit CU. A storage space of one cell unit CU includes one or a plurality of pages.

Each memory cell MT can be configured to store a single-bit value or a multi-bit value. When each memory cell MT can store an n-bit value, a storage capacity per word line WL is equal to the size of n pages, where n is an integer equal to or greater than 1. Here, as an example, a case where a memory cell MT operates in a triple-level cell (TLC) mode in which it stores a 3-bit value. It is noted that an operation mode in which a memory cell MT stores a 1-bit value is referred to as a single-level cell (SLC) mode, an operation mode in which a memory cell MT stores a 2-bit value is referred to as a multi-level cell (MLC) mode, and an operation mode in which a memory cell MT stores a 4-bit value is referred to as a quad-level cell (QLC) mode. The embodiment is also applicable to an operation mode in which the memory cell MT stores the value of a 5-bit or more. A mode in which a memory cell MT stores the value of a 2-bit or more is referred to as a multi-value mode.

In the TLC mode, data of three pages can be stored in one cell unit CU. Among the three pages configured with one cell unit CU, a page to be subjected to writing first is referred to as a lower page, a page to be subjected to writing after the lower page is referred to as a middle page, and a page to be subjected to writing after the middle page is referred to as an upper page. It is noted that there may also be a mode in which programming (that is, writing) is executed collectively on some or all of the plurality of pages configured with one cell unit CU.

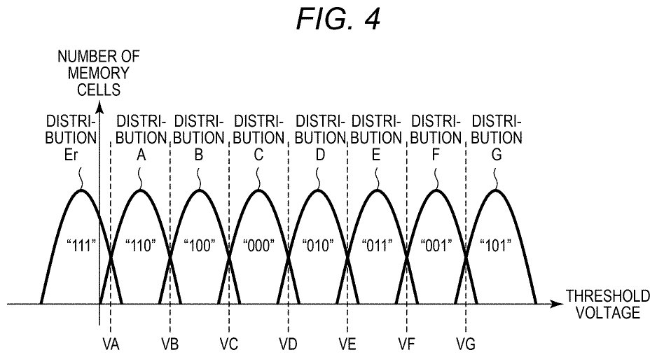

FIG. 4 is a diagram showing an example of a distribution of threshold voltages of memory cell MT operating in a TLC mode. In FIG. 4, the horizontal axis represents a threshold voltage of the memory cell MT, and the vertical axis represents the number of memory cells MT that indicate a certain bit value (data value). The threshold voltage of the memory cell MT has a value corresponding to data to be stored. When the memory cell MT operates in the TLC mode, the threshold voltage of the memory cell MT includes eight distributions: a distribution Er, a distribution A, a distribution B, a distribution C, a distribution D, a distribution E, a distribution F, and a distribution G.

In the TLC mode, the memory cell MT can store 8-value data xyz, defined as data x belonging to the upper page, data y belonging to the middle page, and data z belonging to the lower page. The values of data x, data y, and data z are “0” or “1”.

The threshold voltage of the memory cell MT can be controlled to belong to any one of the eight distributions: the distributions Er, the distribution A, the distribution B, the distribution C, the distribution D, the distribution E, the distribution F, and the distribution G. Correspondence between each distribution and a data value of the 8-value data xyz is predetermined. For example, a data value “111” is allocated to the distribution Er. A data value “110” is allocated to the distribution A. The data values shown in FIG. 4 are allocated to the distributions B to G. It is noted that the correspondence between each distribution and the data value is not limited to the above.

The row decoder 119, the column decoder 115, the data register 116, and the sense amplifier 117 of the flash memory 40 will be described in more detail with reference to FIG. 2. The row decoder 119, the column decoder 115, the data register 116, and the sense amplifier 117 are a part of a peripheral circuit for the memory cell array 118. The peripheral circuit executes accesses of reading, writing, and erasing to the memory cell array 118 under the control of the chip control circuit 112.

In the writing, the column decoder 115 selects and activates a bit line BL corresponding to the column address. The sense amplifier 117 sets the potential of the bit line BL selected by the column decoder 115 to 0 volts. The row decoder 119 applies a programming pulse to a word line WL selected corresponding to the row address. An example of the programming pulse is a pulse of which the voltage gradually increases for each cycle. Thereby, charges are injected into a floating gate of a memory cell MT located at an intersection between the selected bit line BL and the selected word line WL, and consequently, the threshold voltage of the floating gate rises. The sense amplifier 117 confirms whether the threshold voltage of the memory cell MT to be subjected to writing reaches the voltage corresponding to the data stored in the data register 116 for each cycle of the programming pulse. Depending on the result of the confirmation of the sense amplifier 117, the row decoder 119 continues to apply a programming pulse until the threshold voltage of the memory cell MT reaches a voltage based on a data value to be written.

Meanwhile, in the reading, the sense amplifier 117 pre-charges a power supply potential Vcc to the bit line BL. The row decoder 119 selectively or sequentially applies a plurality of read voltages VA, VB, VC, VD, VE, VF, and VG for specifying a distribution for each of the data values “111”, “110”, “100”, “000”, “010”, “011”, “001”, and “101” to the selected word line WL. The value of each read voltage is a voltage value in which the number of error bits in read data is less than the number of error bits that can be corrected by the ECC circuit 30 and no read error occurs. The voltage value in which no read error occurs is also referred to as an appropriate value. The appropriate value depends on the threshold voltage of the memory cell MT provided in the flash memory 40. Before the shipment of the memory system 12, the threshold voltage of the memory cell MT provided in the flash memory 40 is checked, and an appropriate value corresponding to the threshold voltage is determined as a default value of a read voltage. The memory controller 20 transmits the default value to the flash memory 40, causing the flash memory 40 to generate an appropriate read voltage. The read voltage value is expressed in a conversion unit [DAC] of a D/A converter provided in the peripheral circuit. The DAC is the unit of a setting value of a circuit in the flash memory 40 that sets a voltage applied to the D/A converter. The D/A converter converts a digital voltage value transmitted from the memory controller 20 into an analog voltage.

It is noted that, in the reading, the row decoder 119 applies a transfer potential voltage to unselected word lines WL, and keeps the memory cells MT belonging to the unselected word lines WL in an electrically connected state. The sense amplifier 117 detects when charges stored by pre-charging flow out to the source line CELSRC, that is, when a current flows to the corresponding bit line BL, when a certain read voltage is applied, and thereby determines a data value stored in the target memory cell MT. A memory cell MT having a threshold voltage equal to or greater than a read voltage maintains an electrically unconnected state even when a control gate electrode receives a read voltage. Meanwhile, a memory cell MT having a threshold voltage less than the read voltage is electrically connected when the control gate electrode receives a read voltage.

As shown in FIG. 4, a memory cell MT having a threshold voltage less than a read voltage VA between the distribution Er and the distribution A is determined to be included in the distribution Er. In addition, a memory cell MT having a threshold voltage less than a read voltage VB between the distribution A and the distribution B is determined to be included in the distribution Er or the distribution A. Similarly, a memory cell MT having a threshold voltage less than a read voltage between two adjacent distributions is determined to be included in a distribution with the lower threshold voltage out of the two distributions.

The threshold voltage of the memory cell MT changes depending on a stress due to data retention. The stress due to data retention is referred to as a DR stress. The memory cell MT stores data in accordance with its threshold voltage by storing charges in a floating gate. As time elapses since data is written, charges escape from the floating gate due to a DR stress, and the amount of charges stored in the floating gate decreases. When the amount of charges decreases below a certain amount, data cannot be read correctly from the memory cell MT. Since a data writing time differs for each block BLK, a DR stress differs for each block BLK.

When a threshold voltage changes, appropriate values of read voltages VAs, VBs, VCs, VDs, VES, VFs, and VGs also change. For this reason, when reading is executed with the read voltages VA to VG of default values VA0, VB0, VC0, VD0, VE0, VF0, and VG0, which are the appropriate values VAs, VBs, VCs, VDs, VEs, VFs, and VGs determined on the basis of a threshold voltage distribution checked before shipment, the number of error bits (FailBit Count: FBC) in the read data is increased. When the FBC is equal to or greater than the number of error bits that can be corrected by the ECC circuit 30, some error bits uncorrected by the ECC circuit 30 remain. In this case, the memory controller 20 detects a read error.

When the memory controller 20 detects a read error, the memory controller 20 instructs the flash memory 40 to execute retry read for shifting a read voltage value and reading it again. The memory controller 20 instructs the flash memory 40 to execute retry read until no read error is detected. When the FBC is large, latency increases due to the error correction and the retry read, and reading performance decreases.

When a read error is detected even after retry read is executed a particular number of times, an estimation process for an appropriate read voltage value is performed. Details of the estimation process will be described below.

Here, the estimation process for an appropriate read voltage value is described. An example of the estimation process includes determination of a shift candidate value and tracking read. In the determination of the shift candidate value, reading is executed with a read voltage based on a default value, and the number of read bits is obtained. The number of read bits is a total number of memory cells that indicates a certain value. An example of the certain value is “1”. Instead of “1”, “0” may be used as the certain value. An appropriate read voltage value is estimated on the basis of the number of read bits. A shift candidate value, which is a difference between the appropriate read voltage value and the default value, is determined. When the shift candidate value is added to the default value, the estimated appropriate read voltage value is obtained. When the estimated appropriate read voltage value is a value closer to a positive side than the default value, the shift candidate value is a positive value. When the estimated appropriate read voltage value is a value closer to a negative side than the default value, the shift candidate value is a negative value.

When the shift candidate value is determined, tracking read is executed. In the tracking read, reading is executed a plurality of times starting with a read voltage based on a value obtained by shifting the default value by the shift candidate value and with a read voltage based on a plurality of values each shifted further from the shifted value by a fixed value. The plurality of times of reading may be reading with a read voltage based on a value obtained by shifting the default value by the shift candidate value and with a read voltage based on one value further shifted from the shifted value. The appropriate shift value is determined from a change in the number of read bits during the plurality of times of reading. A read voltage based on a value obtained by shifting the default value by the appropriate shift value is an appropriate read voltage.

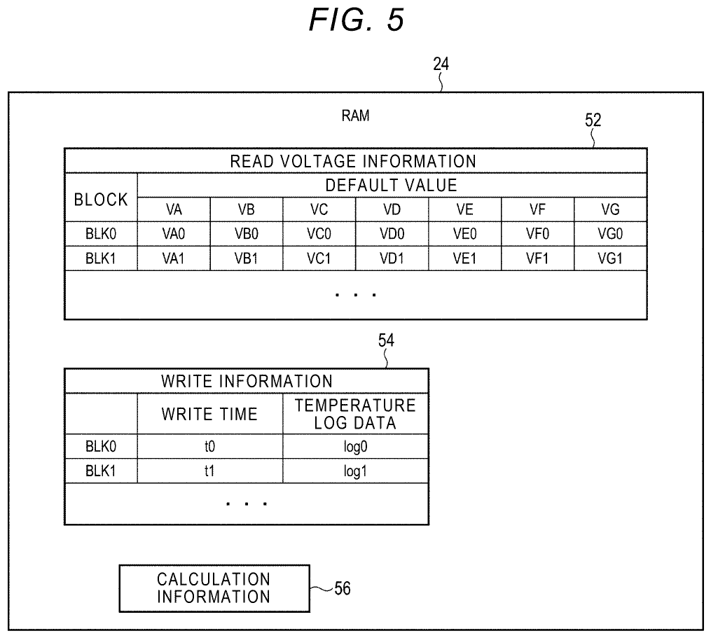

FIG. 5 is a diagram showing an example of data stored in the RAM 24. The RAM 24 stores read voltage information 52, write information 54, and calculation information 56. The read voltage information 52 includes a default value of a read voltage for each block BLK. When a memory cell MT operates in a TLC mode, the read voltage information 52 includes default values of the respective seven read voltages VA to VG. For example, the default value of the block BLK0 is voltages VA0 to VG0, and the default value of the block BLK1 is voltages VA1 to VG1. Before the shipment of the memory system 12, the manufacturer checks the threshold voltage of the memory cell MT for each block BLK, and a default value is determined from the threshold voltage.

The write information 54 includes write time t of the oldest data (data stored the earliest) for each block and the temperature log data. Temperature log data log0 of the block BLK0 includes temperature data for a fixed period of time from write time t0 to the present time. Temperature log data log1 of the block BLK1 includes temperature data for a fixed period of time from write time t1 to the present time.

The calculation information 56 includes coefficients and constants required for calculations performed by the memory controller 20. The read voltage information 52, the write information 54, and the calculation information 56 are stored in the flash memory 40 and made non-volatile when the memory system 12 changes from a conducting state to a non-conducting state. When the memory system 12 is in a conducting state, this non-volatile information is read out from the flash memory 40 and stored in the RAM 24.

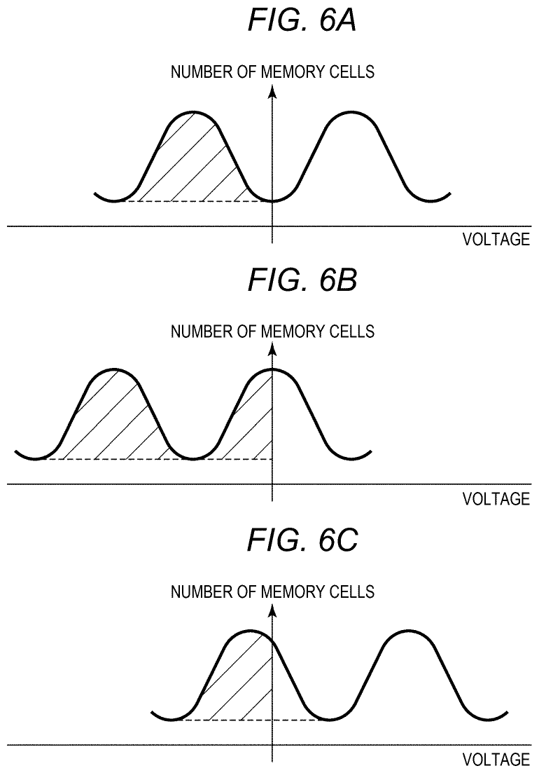

FIGS. 6A to 6C are diagrams showing an example of a change in the number of read bits when the threshold voltage of memory cell changes. The horizontal axis in the diagram represents a threshold voltage and a read voltage, and the center of the horizontal axis is a voltage based on a default value. The vertical axis in the diagram represents the number of memory cells indicating “1” or “0”.

Here, the number of memory cells indicates “1” at a threshold voltage lower than the voltage based on the default value. The area of an inclined part in the drawing corresponds to the number of read bits.

FIG. 6A shows the number of read bits in a state where the threshold voltage of the memory cell does not change since the default value of the read voltage is determined. FIGS. 6(b) and (c) show the number of read bits in a state where the threshold voltage of the memory cell changes since the default value of the read voltage is determined.

As shown in FIG. 6B, when the number of read bits increases from the number of read bits when reading is performed with a read voltage based on a default value, a distribution waveform of the threshold voltage of the memory cell shifts to a negative side. For this reason, an appropriate value also shifts to the negative side, and a shift candidate value becomes a negative value.

Meanwhile, as shown in FIG. 6C, when the number of read bits decreases from the number of read bits when reading is performed with a read voltage based on a default value, a distribution waveform of the threshold voltage of the memory cell shifts to a positive side. For this reason, an appropriate value also shifts to the positive side, and a shift candidate value becomes a positive value.

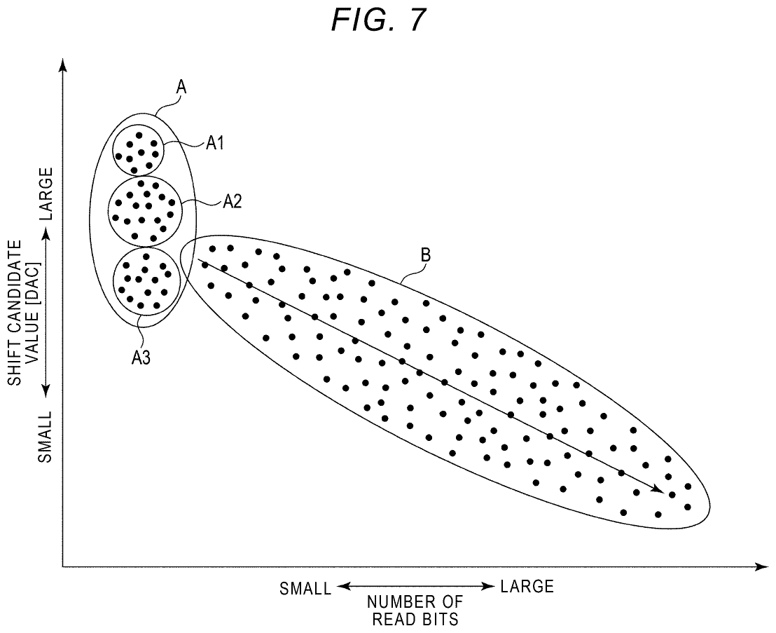

FIG. 7 is a diagram showing an example of a relationship between a shift candidate value and the number of read bits. The number of read bits on the horizontal axis is a large value on the right side and a small value on the left side. When the shift candidate value is positive and negative values, the shift candidate value on the vertical axis is a positive value on the upper side and is a negative value on the lower side. When the shift candidate value is a positive value, an absolute value of the shift candidate value on the vertical axis is a large value on the upper side and is a small value on the lower side. When the shift candidate value is a negative value, an absolute value of the shift candidate value on the vertical axis is a small value on the upper side and is a large value on the lower side. The unit of the shift candidate value is DAC. A relationship between the two values has different characteristics when a DR stress is small immediately after writing and when a DR stress is large after a time elapses since the writing. A DR stress is small means that the DR stress does not exceed a threshold value. Hereinafter, a DR stress is small will be referred to as a small DR stress. A DR stress is large means that the DR stress exceeds the threshold value. Hereinafter, a DR stress is large will be referred to as a large DR stress. A characteristic A represents a relationship of a small DR stress. A characteristic B represents a relationship of a large DR stress. The shift candidate value is a difference between an appropriate read voltage value and a default value. For this reason, FIG. 7 also shows a relationship between an appropriate read voltage value and the number of read bits.

Whether the block BLK corresponds to a large DR stress depends on an elapsed time for which data is written and then left without being read. When the elapsed time exceeds a certain time, it can be determined that the DR stress is large. A change in threshold voltage also depends on the environmental temperature. An example of the environmental temperature is a room temperature. An example of the room temperature is 25° C. In the embodiment, it is determined whether a DR stress is large, on the basis of an elapsed time since writing which is equivalent to the room temperature. The elapsed time equivalent to the room temperature is expressed by Formula 1.

Elapsed time equivalent to room temperature=Actual elapsed time×Acceleration factor Formula 1

The acceleration factor is expressed by Formula 2 from the Arrhenius formula.

$$\begin{matrix}[ Math . 1 ] & \\ Acceleration factor = exp ( \frac{{E}_{a}}{k} ( \frac{1}{{T}_{R T}} - \frac{1}{{T}_{1}} ) & Formula 2\end{matrix}$$

Ea is an activation energy. The unit of the activation energy is electron volt [eV]. The activation energy Ea is measured before the shipment of the memory system.

k is a Boltzmann constant.

TRT is a reference room temperature.

The activation energy Ea, the Boltzmann constant k, and the reference room temperature TRT are stored in the flash memory 40 as calculation information 56.

T1 is an environmental temperature. In a case of conduction where the memory system 10 is in an electrically connected state and continues to a normal operation, the environmental temperature T1 is calculated with reference to the value of the temperature sensor 50. In a case of non-conduction where the memory system 10 is in an electrically unconnected state and does not operate, the environmental temperature T1 cannot be calculated. When the memory system 10 is in an electrically connected state, the host 14 takes in the value of a temperature sensor outside the memory system 10 before conduction, and provides the value to the memory system 10 to obtain the environmental temperature T1. The elapsed time equivalent to the room temperature is calculated at fixed time intervals in accordance with Formula 1. A maximum temperature in temperature log data during a fixed period of time (between the previous calculation and the current calculation) is only required to be used as the environmental temperature T1.

It is noted that, when the unit of the activation energy Ea is Joule [J], an acceleration factor is expressed by Formula 3.

$$\begin{matrix}[ Math . 2 ] & \\ Acceleration factor = exp ( \frac{{E}_{a}}{k} ( \frac{1}{{T}_{R T}} - \frac{1}{{T}_{1}} ) & Formula 3\end{matrix}$$

TRT is a reference room temperature.

R is a gas constant.

In order to determine whether a DR stress is large, an elapsed time equivalent to the room temperature is compared with a threshold time. When the elapsed time equivalent to the room temperature is shorter than the threshold time, it is determined that the DR stress is small. When the elapsed time equivalent to the room temperature is longer than or equal to the threshold time, it is determined that the DR stress is large.

As shown in the characteristic B in FIG. 7, when it is determined that a DR stress is large, there is a certain range of shift candidate values for a certain number of read bits. When the shift range of the voltage value during tracking read is within this extent, the shift candidate value and the number of read bits can be regarded as having a linear relationship. When the number of read bits is x, a shift candidate value y is expressed by Formula 4 which is a linear function.

$$y = ax + b \qquad Formula 4$$

a and b are constants determined by simulation. The constants a and b are stored in the RAM 24 as calculation information 56.

When it is determined that a DR stress is large, the shift candidate value y is uniquely determined on the basis of the number of read bits x in accordance with Formula 4.

When it is determined that a DR stress is small, as shown in the characteristic A in FIG. 7, shift candidate values exist in a wider range than the range in the characteristic B for the same number of read bits. In this case, it is difficult to determine a shift candidate value from the number of bits. The characteristic A is divided into sub-characteristics A1, A2, and A3 having different ranges of shift candidate values. Shift candidate values of the sub-characteristic A1 are distributed in a first range. The first range is a range closet to the positive side among the three ranges. Shift candidate values of the sub-characteristic A3 are distributed in a third range. The third range is a range closet to the negative side among the three ranges. Shift candidate values of the sub-characteristic A2 are distributed in a second range between the first and second ranges.

One of the sub-characteristics A1, A2, and A3 is used to determine a shift candidate value. For example, when the sub-characteristic A1 is used, a shift candidate value is a first value in the first range. When the sub-characteristic A2 is used, a shift candidate value is a second value in the second range. When the sub-characteristic A3 is used, a shift candidate value is a third value in the third range. The shift candidate values of the respective sub-characteristics A1, A2, and A3 may be determined to be any values within the respective ranges.

When the shift candidate value is determined, an appropriate shift value is determined by tracking read based on the determined shift candidate value. When reading is performed with a read voltage based on the appropriate shift value and a read error occurs, one of the other sub-characteristics A1, A2, or A3 is used to determine a new shift candidate value. An appropriate shift value is determined again by tracking read based on the new shift candidate value. When reading is performed with a read voltage based on the appropriate shift value and a read error occurs, one of the remaining sub-characteristics A1, A2, or A3 is used to determine a new shift candidate value.

When a DR stress is small, a change in the threshold voltage of the memory cell changes depending on a temperature crossover during read. The temperature crossover is a difference between the environmental temperature when data is written and the environmental temperature when data is read out. For this reason, depending on which of the sub-characteristics A1, A2, and A3 is used to determine a shift candidate value, the possibility of a read error occurring when reading is performed with an appropriate read voltage differs. The sub-characteristics A1, A2, and A3 used to determine a shift candidate value have a priority order depending on a temperature crossover. Experimental results show that the priority order of the sub-characteristics A1, A2, and A3 changes when the temperature crossover is small and when the temperature crossover is large. A temperature crossover being small means that the temperature crossover does not exceed a threshold temperature. A temperature crossover being large means that the temperature crossover exceeds a threshold temperature.

When a temperature crossover is small, that is, when the temperature crossover does not exceed the threshold temperature, it was found that, when a shift candidate value is determined using the sub-characteristic A3, the possibility of a read error occurring is lowest, and when a shift candidate value is determined using the sub-characteristic A1, the possibility of a read error occurring is highest. For this reason, when a temperature crossover is small, the sub-characteristic A3, the sub-characteristic A2, and the sub-characteristic A1 are used in this order to determine an appropriate shift value. That is, a shift candidate value is first set to a third value, and an appropriate shift value is determined by tracking read. Reading is performed on the basis of this, and when a read error occurs, a shift candidate value is set to a second value, and an appropriate shift value is determined by tracking read. Reading is performed on the basis of this, and when a read error occurs, a shift candidate value is set to a first value.

When a temperature crossover is large, that is, when the temperature crossover exceeds a threshold temperature, it was found that the possibility of a read error occurring is lowest when a shift candidate value is determined using the sub-characteristic A2, and the possibility of a read error occurring is highest when a shift candidate value is determined using the sub-characteristic A3. For this reason, the sub-characteristic A2, the sub-characteristic A1, and the sub-characteristic A3 are used in this order to determine a shift candidate value. That is, the shift candidate value is first set to a second value, is then set to a first value, and is finally set to a third value.

In tracking read, reading is executed a plurality of times with a read voltage based on a value obtained by shifting a default value by a shift candidate value and with a read voltage based on values each shifted further from the shifted value by a fixed value. From a change in the number of read bits during a plurality of times of reading, distribution waveforms shown in FIGS. 4 and 6 can be approximately obtained. A voltage value of a valley where two distributions overlap each other is an appropriate read voltage value. A difference between the default value and the appropriate read voltage value is an appropriate shift value.

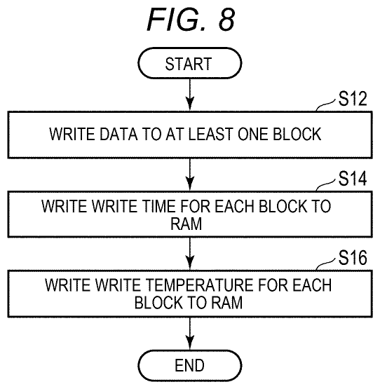

FIG. 8 is a flowchart showing an example of a write process of the memory controller 20.

The memory controller 20 writes data to at least one block BLK (S12).

The memory controller 20 acquires a time from the timer of the CPU 28, and writes the acquired time t0 the RAM 24 as a write time t for each block BLK in the write information 54 (S14). The write time t is, for example, the time at which writing starts.

The memory controller 20 acquires a temperature from the temperature sensor 50 and writes the acquired temperature to the RAM 24 as temperature log data for each block BLK in the write information 54 (S16).

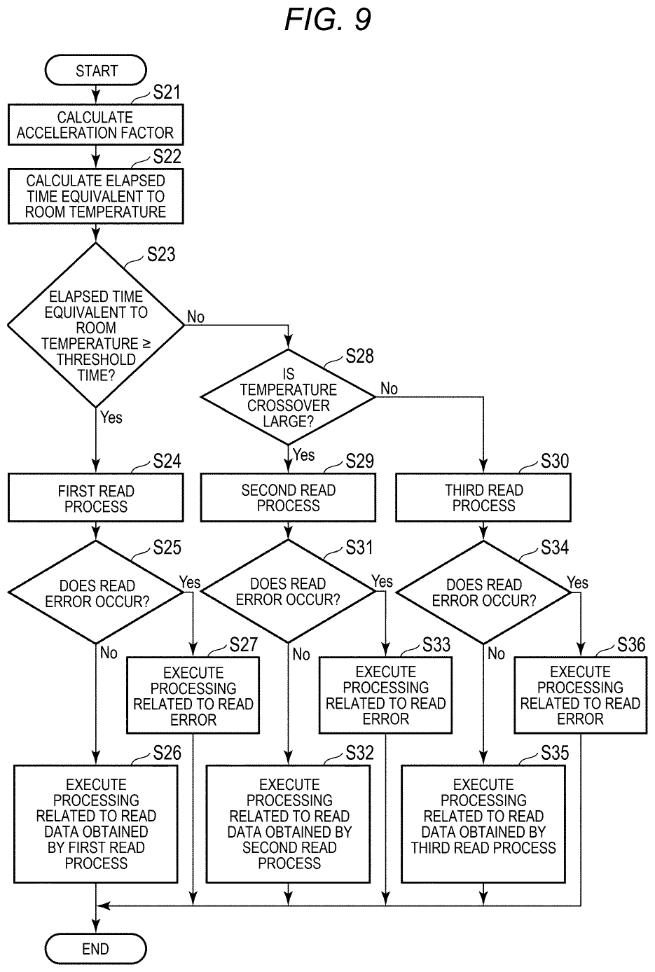

FIG. 9 is a flowchart showing an example of a read process of the memory controller 20.

The memory controller 20 acquires an environmental temperature T1 from the temperature sensor 50, reads coefficients and constants in the calculation information 56 from the RAM 24, and calculates an acceleration factor in accordance with Formula 2 (S21).

The memory controller 20 acquires the current time from the timer of the CPU 28, reads out the write time t and the temperature log data of the read target block BLK in the write information 54 from the RAM 24, and calculates an elapsed time equivalent to the room temperature in accordance with Formula 1 (S22).

The memory controller 20 determines whether the elapsed time equivalent to the room temperature is longer than or equal to a threshold time (S23).

When the memory controller 20 determines that the elapsed time equivalent to the room temperature is longer than or equal to the threshold time (Yes in S23), the memory controller 20 determines that a DR stress is large, and executes a first read process (S24).

After the first read process (S24), the memory controller 20 determines whether a read error occurs (S25). When no read error occurs (No in S25), the memory controller 20 executes processing related to the read data obtained by the first read process (S24) (S26). When a read error occurs (Yes in S25), the memory controller 20 executes processing related to the read error (S27). After (S26) and (S27), the memory controller 20 ends the read process (first read process).

When the memory controller 20 determines that the elapsed time equivalent to the room temperature is shorter than the threshold time (No in S23), the memory controller 20 determines that a DR stress is small. When it is determined that the DR stress is small, it is considered that the threshold voltage of the memory cell is greatly affected by temperature crossover. For this reason, the memory controller 20 acquires an environmental temperature T1 from the temperature sensor 50, reads out a write temperature temp of a block BLK to be read in the write information 54 from the RAM 24, and determines whether the temperature crossover is large depending on whether a difference between the environmental temperature T1 and the write temperature temp exceeds a threshold temperature (S28).

When the memory controller 20 determines that the temperature crossover is large (Yes in S28), the memory controller 20 executes a second read process (S29). When the memory controller 20 determines that the temperature crossover is not large, that is, that the temperature crossover is small (No in S28), the memory controller 20 executes a third read process (S30).

After the second read process (S29), the memory controller 20 determines whether a read error occurs (S31). When no read error occurs (No in S31), the memory controller 20 executes processing related to read data obtained by the second read process (S29) (S32). When a read error occurs (Yes in S31), the memory controller 20 executes processing related to the read error (S33). After (S32) and (S33), the memory controller 20 ends the read process (second read process).

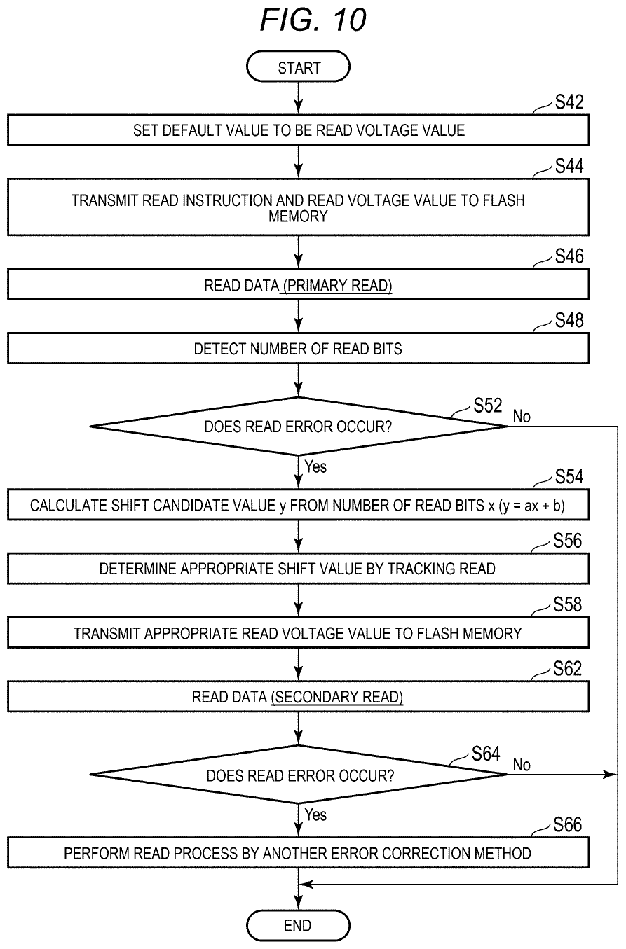

After the third read process (S30), the memory controller 20 determines whether a read error occurs (S34). When no read error occurs (No in S34), the memory controller 20 executes processing related to the read data obtained by the third read process (S30) (S35). When a read error occurs (Yes in S34), the memory controller 20 executes processing related to the read error (S36). After (S35) and (S36), the memory controller 20 ends the read process (third read process). FIG. 10 is a flowchart showing an example of the first read process (S24 in FIG. 9) when it is determined that a DR stress is large.

The memory controller 20 reads out a default value of a block BLK to be read in the read voltage information 52 from the RAM 24, and sets the default value to be a read voltage value (S42).

The memory controller 20 transmits a read instruction and the read voltage value to the flash memory 40 (S44).

The flash memory 40 reads the data (i.e., performs a primary read) using a read voltage based on the read voltage value (S46). The read voltage used in (S46) is also referred to as a first read voltage. The read data is transmitted to the memory controller 20.

The memory controller 20 detects the number of read bits (S48). The number of read bits in (S48) is also referred to as a first number of read bits.

The ECC circuit 30 performs error correction on the read data. When the ECC circuit 30 cannot perform error correction, it detects a read error. The memory controller 20 determines whether a read error occurs (S52).

When the memory controller 20 determines that no read error occurs (No in S52), it ends the first read process.

When the memory controller 20 determines that a read error occurs (Yes in S52), the memory controller 20 calculates a shift candidate value y from the number of read bits x in accordance with Formula 4 (S54).

The memory controller 20 determines an appropriate shift value by tracking read (S56). Specifically, the memory controller 20 reads out a default value of a block BLK to be read from the read voltage information 52 in the RAM 24, and transmits a read voltage value, which is obtained by adding a shift candidate value to the default value, and read voltage values each shifted further from the read voltage value by a fixed value to the flash memory 40, and reads data a plurality of times (tracking read). A read voltage according to the read voltage value obtained by adding the shift candidate value to the default value is also referred to as a second read voltage. A read voltage according to the read voltage values each shifted further from the read voltage value, which is obtained by adding the shift candidate value to the default value, by a fixed value is also referred to as a third read voltage. The memory controller 20 detects the number of read bits during reading. The number of read bits detected by the tracking read is also referred to as a second number of read bits. The memory controller 20 determines an appropriate shift value, which is a difference between a voltage value of an appropriate read voltage and the default value, from a changes in the number of read bits detected through a plurality of times of reading (S56).

The memory controller 20 transmits the appropriate read voltage value, which is obtained by shifting the default value by the appropriate shift value, to the flash memory 40 (S58).

The flash memory 40 reads data (i.e., performs a secondary read) using the appropriate read voltage based on the appropriate read voltage value (S62). The appropriate read voltage based on the appropriate read voltage value is also referred to as a fourth read voltage. The read data is transmitted to the memory controller 20.

The ECC circuit 30 performs error correction on the read data. When ECC circuit 30 cannot perform error correction, it detects a read error. The memory controller 20 determines whether a read error occurs (S64).

When the memory controller 20 determines that no read error occurs (No in S64), it ends the first read process.

When the memory controller 20 determines that a read error occurs (Yes in S64), the memory controller 20 executes a read process by an error correction method other than the error correction method executed in (S52) (S66). For example, in the error correction executed in (S52), when data to be encoded is data in one memory chip 42, the data to be encoded is data spanning a plurality of memory chips 42 in the error correction executed in (S66). For example, when a correction frame length of the error correction executed in (S52) is a first length, a correction frame length of the error correction executed in (S66) is a second length that is longer than the first length. For example, when the number of correction frames of the error correction executed in (S52) is a first number, the number of correction frames of the error correction executed in (S66) is a second number that is greater than the first number. After (S66), the memory controller 20 ends the first read process.

In the first read process, a shift candidate value is calculated from the number of read bits using a linear function. In the related art, a shift candidate value is determined using information in which the shift candidate value is determined for the range of the number of read bits. For this reason, when the number of bits includes an error, the shift candidate value may change significantly (become erroneous). In this embodiment, a shift candidate value is determined by calculation from the number of read bits. For this reason, when the number of read bits includes an error, the influence of the error does not increase.

The second read process (S29 in FIG. 9) when it is determined that the DR stress is small and the temperature crossover is large includes a first example and a second example. First, the first example of the second read process will be described.

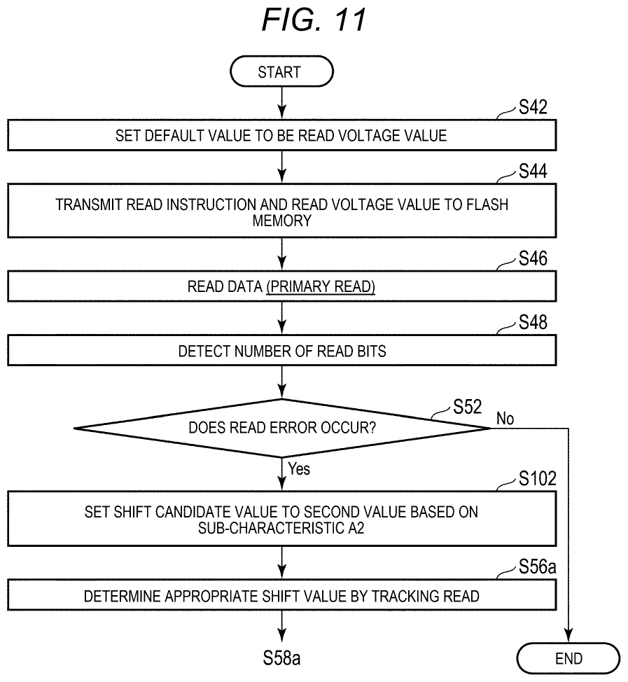

FIGS. 11, 12, and 13 are flowcharts showing the first example of the second read process. Processes corresponding to those in FIG. 10 are given the same reference numerals, and detailed descriptions thereof are omitted. In the first example of the second read process, the memory controller 20 executes (S42) to (S52), and then sets a shift candidate value to a second value on the basis of the sub-characteristic A2 instead of executing S54 in FIG. 10 (S102).

Similarly to the case of the first read process, the memory controller 20 determines an appropriate shift value by tracking read (S56a) and transmits an appropriate read voltage value to the flash memory 40 (S58a). Thereafter, data reading (i.e., secondary read) is executed (S62a), and the memory controller 20 determines whether a read error occurs (S64a). When the memory controller 20 determines that no read error occurs, the memory controller 20 ends the first example of the second read process.

When the memory controller 20 determines that a read error occurs (Yes in S64a), the memory controller 20 sets a shift candidate value to a first value on the basis of the sub-characteristic A1 (S10 4).

The memory controller 20 determines an appropriate shift value by tracking read (i.e., secondary tracking read) (S56b) and transmits an appropriate read voltage value to the flash memory 40 (S58b). Thereafter, data reading (i.e., tertiary read) is executed (S62b), and the memory controller 20 determines whether a read error occurs (S64b). When the memory controller 20 determines that no read error occurs, the memory controller 20 ends the first example of the second read process.

When the memory controller 20 determines that a read error occurs, (Yes in S64b), the memory controller 20 sets a shift candidate value to a third value on the basis of the sub-characteristic A3 (S106).

The memory controller 20 determines an appropriate shift value by tracking read (i.e., tertiary tracking read) (S56c), and transmits an appropriate read voltage value to the flash memory 40 (S58c). Thereafter, data reading (i.e., quaternary read) is executed (S62c), and the memory controller 20 determines whether a read error occurs (S64c). When the memory controller 20 determines that no read error occurs, the memory controller 20 ends the first example of the second read process.

When the memory controller 20 determines that a read error occurs (Yes in S64c), the memory controller 20 executes a read process by another error correction method (S66). After (S66), the memory controller 20 ends the first example of the second read process.

Next, the second example of the second read process will be described.

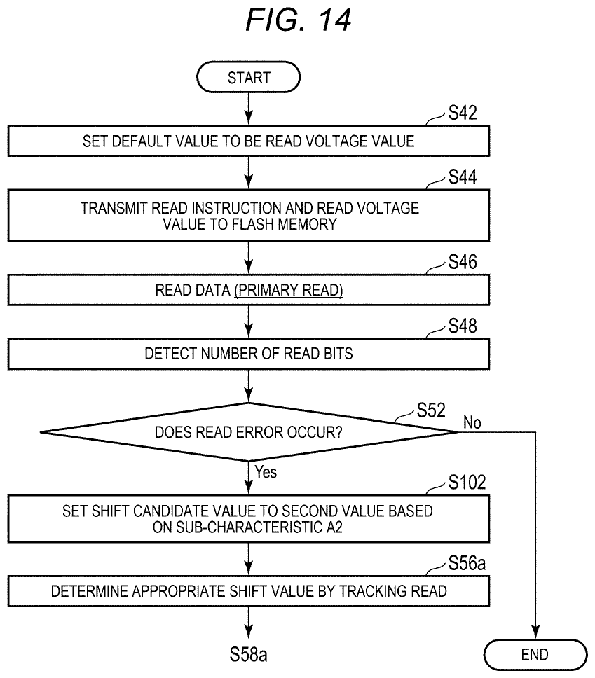

FIGS. 14, 15, and 16 are flowcharts showing the second example of the second read process. In FIGS. 14, 15, and 16, the same processes as those in FIGS. 11, 12, and 13 are denoted by the same reference numerals, and detailed descriptions thereof are omitted. The memory controller 20 executes (S42) to (S52), and sets a shift candidate value to a second value on the basis of the sub-characteristic A2 in (S102). Then, the memory controller 20 executes a process from the determination of an appropriate shift value by tracking read to data reading in (S56a), (S58a), and (S62a), and determines whether a read error occurs (S64a). When the memory controller 20 determines that no read error occurs (No in S64a), the memory controller 20 ends the second example of the second read process.

When the memory controller 20 determines that a read error occurs (Yes in S64a), the memory controller 20 executes a read process by another error correction method (S66a). The memory controller 20 determines whether a read error occurs in the read process using another error correction method (S68a). When the memory controller 20 determines that no read error occurs in the read process using another error correction method (No in S68a), the memory controller 20 ends the second example of the second read process.

When the memory controller 20 determines that a read error occurs in the read process using another error correction method (Yes in S68a), the memory controller 20 sets a shift candidate value to a first value on the basis of the sub-characteristic A1 (S104). Thereafter, the memory controller 20 executes a process from the determination of an appropriate shift value by tracking read to data reading in (S56b), (S58b), and (S62b), and determines whether a read error occurs (S64b). When the memory controller 20 determines that no read error occurs (No in S64b), the memory controller 20 ends the second example of the second read process.

When the memory controller 20 determines that a read error occurs (Yes in S64b), the memory controller 20 executes a read process by another error correction method (S66b). The memory controller 20 determines whether a read error occurs in the read process using another error correction method (S68b). When the memory controller 20 determines that no read error occurs in the read process using another error correction method (No in S68b), the memory controller 20 ends the second example of the second read process.

When the memory controller 20 determines that a read error occurs in the read process using another error correction method (Yes in S68b), the memory controller 20 sets a shift candidate value to a third value on the basis of the sub-characteristic A3 (S106). Thereafter, the memory controller 20 executes a process from the determination of an appropriate shift value by tracking read to data reading in (S56c), (S58c), and (S62c), and determines whether a read error occurs (S64c). When the memory controller 20 determines that no read error occurs (No in S64c), the memory controller 20 ends the second example of the second read process.

When the memory controller 20 determines that a read error occurs (Yes in S64c), the memory controller 20 executes a read process by another error correction method (S66c). After (S66c), the memory controller 20 ends the second example of the second read process.

The third read process (S36) when it is determined that the DR stress is small and the temperature crossover is small also includes a first example and a second example. First, the first example of the third read process will be described.

The first example of the third read process (S36) is the same as the first example of the second read process, except for the priority order of the three sub-characteristics A1, A2, and A3 used when determining the shift candidate value.

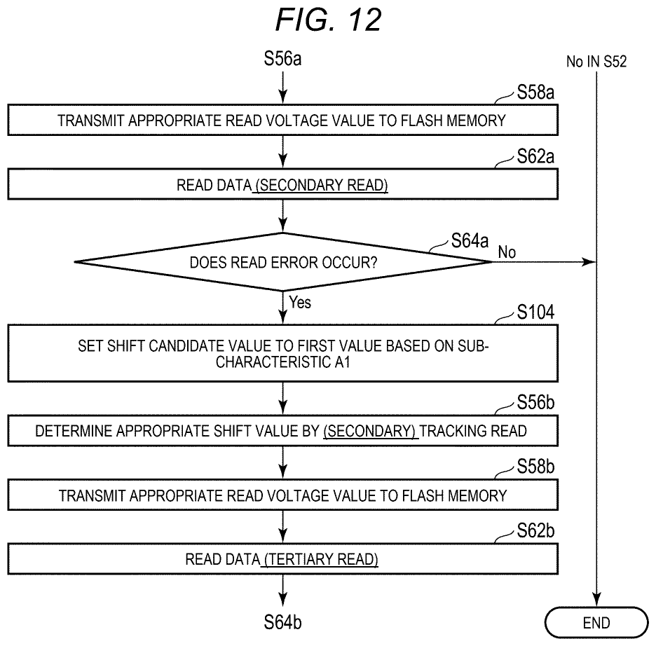

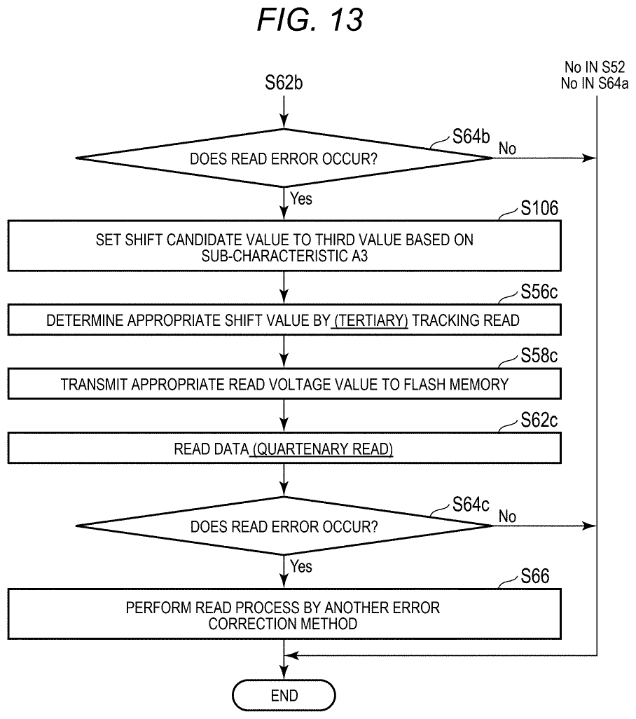

In the first example of the second read process shown in FIG. 11, FIG. 12, and FIG. 13, the shift candidate value is determined using the sub-characteristic A2 in (S102), the sub-characteristic A1 in (S104), and the sub-characteristic A3 in (S106) in this order. In the first example of the third read process, the shift candidate value is determined using the sub-characteristic A3, the sub-characteristic A2, and the sub-characteristic A1 in this order. For this reason, the flowchart showing the first example of the third read process is the same as those of FIG. 11, FIG. 12, and FIG. 13 showing the first example of the second read process, with some parts changed. For this reason, the illustration of a flowchart showing the first example of the third read process is omitted.

In the first example of the third read process, the memory controller 20 sets a shift candidate value to a third value on the basis of the sub-characteristic A3 instead of executing S102 in FIG. 11. The memory controller 20 sets a shift candidate value to a second value on the basis of the sub-characteristic A2 instead of executing S104 in FIG. 12. The memory controller 20 sets a shift candidate value to a first value on the basis of the sub-characteristic A1 instead of executing S106 in FIG. 13. The other processes in the first example of the third read process are the same as those in the first example of the second read process.

Next, the second example of the third read process will be described.

The second example of the third read process (S36) is the same as the second example of the second read process, except for the priority order of the three sub-characteristics A1, A2, and A3 used when determining the shift candidate value.

In the second example of the second read process shown in FIGS. 14, 15, and 16, the shift candidate value is determined using the sub-characteristic A2 (S102), the sub-characteristic A1 (S104), and the sub-characteristic A3 (S106) in this order. In the second example of the third read process, the shift candidate value is determined using the sub-characteristic A3, the sub-characteristic A2, and the sub-characteristic A1 in this order. For this reason, the flowchart showing the second example of the third read process is the same as those of FIGS. 14, 15, and 16 showing the second example of the second read process, with some parts changed. For this reason, the illustration of a flowchart showing the second example of the third read process is omitted.

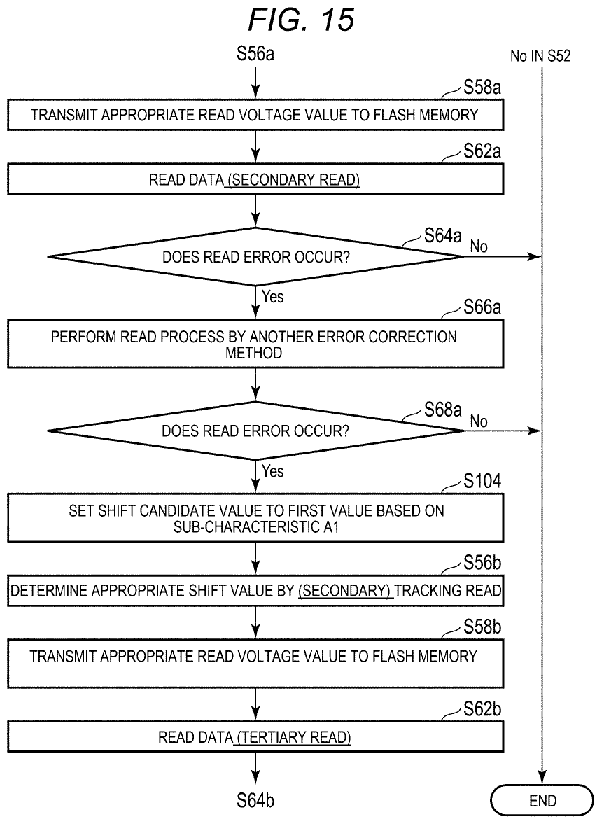

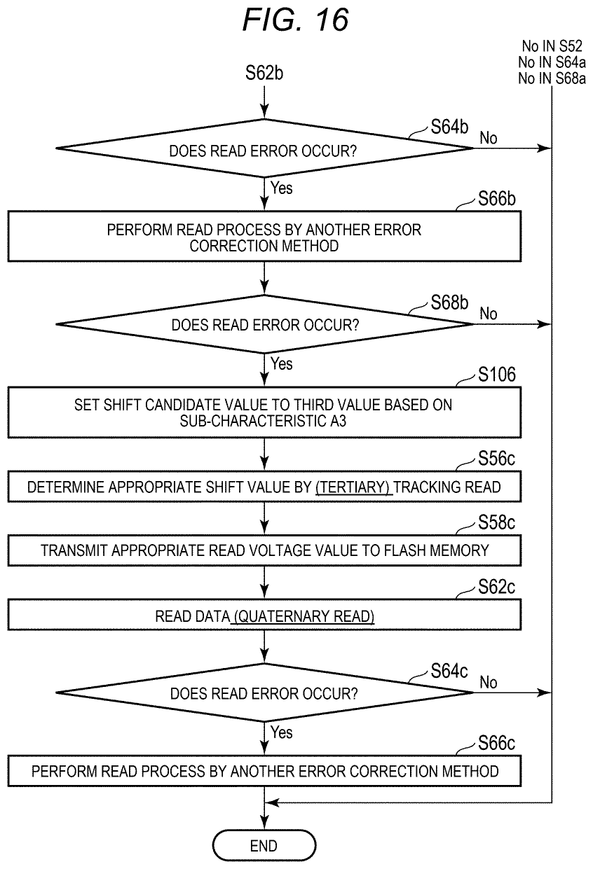

In the second example of the third read process, the memory controller 20 sets a shift candidate value to a third value on the basis of the sub-characteristic A3 instead of executing S102 in FIG. 14. The memory controller 20 sets a shift candidate value to a second value on the basis of the sub-characteristic A2 instead of executing S104 in FIG. 15. The memory controller 20 sets a shift candidate value to a first value on the basis of the sub-characteristic A1 instead of executing S106 in FIG. 16. The other processes in the second example of the third read process are the same as those in the second example of the second read process.

The memory system and the reading method according to the embodiments use an appropriate determination method in accordance with whether or not a DR stress is large and, when no DR stress is received, whether or not a temperature crossover is large, when determining a shift candidate value for determining an appropriate read voltage value. For this reason, an appropriate shift candidate value is determined from the number of read bits. When the shift candidate value is not appropriate, it is not possible to approximate a distribution waveform of a threshold voltage of memory cell by tracking read and to find a valley where two distributions overlap each other. In a memory system of which the storage mode is a multi-value mode, when a shift candidate value is not appropriate, there is a possibility that a valley between two other distributions different from the two target distributions will be found. In the embodiments, an appropriate shift candidate value for the two target distributions is determined, and thus tracking read is executed correctly, and even when a threshold voltage of memory cell changes, a read process can be executed with an appropriate read voltage, reducing latency and improving reading performance.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A memory system comprising:
a non-volatile memory including a plurality of memory cells;
a controller connected to the non-volatile memory and configured to:
calculate a parameter value representing a data retention stress; and
perform a read operation to read data from the non-volatile memory, the read operation including: i) a primary read using a first read voltage; ii) a tracking read to determine an optimum read voltage when a first error correction with respect to data read through the primary read fails; and iii) a secondary read using the optimum read voltage, wherein
the tracking read comprises data read using, as an initial read voltage thereof, a read voltage that is shifted from the first read voltage by a shift value, and then using one or more read voltages further shifted from the initial read voltage, and
the controller is configured to determine the shift value to be a first shift value based on a bit count of data read through the primary read when the parameter value is greater than a first threshold.

2. The memory system according to claim 1, wherein the controller is configured to calculate the parameter value using a period of time that has elapsed since writing of the data to be read through the read operation and a log of temperature at or around the memory system.

3. The memory system according to claim 1, wherein the read operation further includes: iv) a second error correction with respect to data read through the secondary read, the second error correction being different from the first error correction at least in a length of an error correction frame or a span of data encoded.

4. The memory system according to claim 1, wherein the controller is configured to determine the shift value to be the first shift value using a linear function of the bit count of the read data.

5. The memory system according to claim 4, wherein the controller is configured to store one or more constants of the linear function in the non-volatile memory.

6. The memory system according to claim 1, wherein the controller is configured to determine the shift value to be a second shift value based on a temperature difference between a first temperature at writing of the data to be read through the read operation and a second temperature at the read operation, when the parameter value is less than the first threshold.

7. The memory system according to claim 6, further comprising:
a temperature sensor, wherein
the controller is configured to maintain a temperature obtained from the temperature sensor at the writing as the first temperature and obtain a temperature from the temperature sensor at the read operation as the second temperature.

8. The memory system according to claim 6, wherein the second shift value is a first predetermined value when the temperature difference is less than a second threshold, and a second predetermined value greater than the first predetermined value when the temperature difference is greater than the second threshold.

9. The memory system according to claim 8, wherein the read operation further includes: iv) a secondary tracking read to determine an updated optimum read voltage when the first error correction with respect to data read through the secondary read fails; and v) a tertiary read using the updated optimum read voltage.

10. The memory system according to claim 9, wherein the secondary tracking read comprises data read using, as an initial read voltage thereof,
a read voltage shifted from the first read voltage by the second predetermined value when the second shift value used in the tracking read is the first predetermined value, and
a read voltage shifted from the first read voltage by a third predetermined value greater than the second predetermined value when the second shift value used in the tracking read is the second predetermined value.

11. The memory system according to claim 8, wherein the read operation further includes: iv) a second error correction with respect to data read through the secondary read, the second error correction being different from the first error correction at least in a length of an error correction frame or a span of data encoded; v) a secondary tracking read to determine an updated optimum read voltage when the second error correction fails; and vi) a tertiary read using the updated optimum read voltage.

12. The memory system according to claim 11, wherein the secondary tracking read comprises data read using, as an initial read voltage thereof,
a read voltage shifted from the first read voltage by the second predetermined value when the second shift value used in the tracking read is the first predetermined value, and
a read voltage shifted from the first read voltage by a third predetermined value greater than the second predetermined value when the second shift value used in the tracking read is the second predetermined value.

13. The memory system according to claim 1, wherein the first read voltage is a default read voltage set for the memory system, the default read voltage being stored in the non-volatile memory.

14. The memory system according to claim 1, wherein the first read voltage is one of a set of read voltages to read multi-bit data from each memory cell of the plurality of memory cells.

15. A method for controlling a memory system comprising a non-volatile memory including a plurality of memory cells, the method comprising:
calculating a parameter value representing a data retention stress; and
performing a read operation to read data from the non-volatile memory, the read operation including: i) a primary read using a first read voltage; ii) a tracking read to determine an optimum read voltage when a first error correction with respect to data read through the primary read fails; and iii) a secondary read using the optimum read voltage, wherein
the tracking read comprises data read using, as an initial read voltage thereof, a read voltage that is shifted from the first read voltage by a shift value, and then using one or more read voltages further shifted from the initial read voltage,
the shift value is a first shift value determined based on a bit count of data read through the primary read when the parameter value is greater than a first threshold, and
the shift value is a second shift value determined based on a temperature difference between a first temperature at writing of the data to be read through the read operation and a second temperature at the read operation, when the parameter value is less than the first threshold.

16. The method according to claim 15, wherein the parameter value is calculated using a period of time that has elapsed since writing of the data to be read through the read operation and a log of temperature at or around the memory system.

17. The method according to claim 15, wherein the read operation further includes: iv) a second error correction with respect to data read through the secondary read, the second error correction being different from the first error correction at least in a length of an error correction frame or a span of data encoded.

18. The method according to claim 15, wherein the second shift value is a first predetermined value when the temperature difference is less than a second threshold, and a second predetermined value greater than the first predetermined value when the temperature difference is greater than the second threshold.

19. The method according to claim 18, wherein the read operation further includes: iv) a secondary tracking read to determine an updated optimum read voltage when the first error correction with respect to data read through the secondary read fails; and v) a tertiary read using the updated optimum read voltage.

20. The method according to claim 15, further comprising determining the shift value to be the first shift value using a linear function of the bit count of the read data.
